(19) United States
(12) Patent Application Publication
(10) Pub. No.: US 2021/0294175 A1
(43) Pub. Date: Sep. 23, 2021

(54) COLOR FILTER IN A COLOR ELECTROPHORETIC DISPLAY ARRANGEMENT AND METHOD FOR MANUFACTURING THEREOF

(71) Applicant: PLASTIC LOGIC HK LIMITED, Central (HK)

(72) Inventor: Andreas DOEBELT, Dresden (DE)

(73) Assignee: PLASTIC LOGIC HK LIMITED, Central (HK)

(21) Appl. No.: 17/205,570

(22) Filed: Mar. 18, 2021

(30) Foreign Application Priority Data
Mar. 19, 2020 (EP) 20164186.7
Apr. 17, 2020 (EP) 20170179.4

(51) Int. Cl. G02F 1/1677; G02F 1/167; G02F 1/1335; G02F 1/1339

(52) U.S. Cl. CPC G02F 1/1677; G02F 1/1339; G02F 1/133516; G02F 1/167

(57) ABSTRACT

The invention relates to a method for manufacturing an inkjet color filter (1) arranged on an electrophoretic display (2) and a color filter (1) comprising an electrophoretic display media (3) arranged on a backplane, executed by the steps of arranging an upper optical clear adhesive layer (8), arranging a top encapsulation film (9) and a color pattern (7) between the electrophoretic media (3) and the top encapsulation film (9). The upper optical clear adhesive layer (8) is applied before inkjet printing the color pattern (7) wherein the optical clear adhesive layer function as an image receiving layer.

### CROSS REFERENCE AND CLAIM OF PRIORITY

This application claims priority to European Patent Application No. 20164186.7 filed on Mar. 19, 2020 and European Patent Application No. 20170179.4 filed on Apr. 17, 2020, the contents of each of which are incorporated herein by reference in their entireties.

### FIELD OF INVENTION

The invention relates to a method for manufacturing a color filter in a color electrophoretic display arrangement. The color electrophoretic display arrangement comprises an electrophoretic display media arranged on a backplane, i.e., a substrate provided with a pixel driving array. The method involves the steps of arranging a top encapsulation film attached by an upper optical clear adhesive layer within the color electrophoretic display arrangement and arranging a color pattern between the electrophoretic display media and the top encapsulation film.

The invention also relates to a color electrophoretic display arrangement comprising an electrophoretic display media arranged on a backplane, i.e. a substrate provided with a pixel driving array, having a top encapsulation film attached by an upper optical clear adhesive layer within the color electrophoretic display arrangement and a color pattern between the electrophoretic display media and the top encapsulation film.

Summarizing, the invention relates to color filter manufacturing as part of assembly process of a flexible electrophoretic display arrangement. It can also get applied to color filter manufacturing as part of process of a rigid electrophoretic display arrangement or other kinds of displays using color filters.

### BACKGROUND

As shown in FIG. 1 (prior art), manufacturing a color filter 1 of an electrophoretic display arrangement 2 on top of an electrophoretic display media 3 where the electrophoretic display media 3 is arranged on a backplane 4 i.e. a substrate provided with a pixel driving array (not shown) involves the process steps of:
1. Depositing a lower optical clear adhesive layer 5 onto the electrophoretic display media 3;
2. laminating a color pattern layer 6, e.g. pre-manufactured by a photolithography process including a color pattern 7; attached by the lower optical clear adhesive layer 5
3. Depositing an upper optical clear adhesive layer 8 onto the color pattern layer 6; and
4. laminating a top encapsulation film 9 attached by the upper optical clear adhesive layer 8.

Other process technologies use liquid resin for optical bonding of the top encapsulation film 9, but the invention herein is applied for technology using the upper optical clear adhesive layer 8 for lamination of an encapsulation film 9.

The basic idea of the invention is to use inkjet printing to produce the color pattern while reducing the manufacturing effort.

Generally, to perform inkjet printing on a surface, the surface must be receptive to the ink. To enable inkjet printing for the color pattern, an image receiving layer should have been applied to the surface of the electrophoretic display media.

The basic function of the ink receiving layer (also called IRL, image receiving layer, image receiving liquid, priming layer, etc.) is to ensure a good reception of ink droplets for precise placement and reduction of “coffee stain effect”. Both are not easy to achieve by printing on the surface of the electrophoretic display, especially a pure PET, PEN or other flexible substrate material surfaces.

The ink receiving layer has usually an “instant solvent reception” property (for solvent ink) and influences the surface tension between ink and a surface allowing a good reception of ink droplets. The process of creating the image receiving layer on top of electrophoretic display media is a “wet process”. The image receiving layer material is diluted in solvent and coated to the electrophoretic display media as liquid. After the solvent is removed by following drying process the remaining image receiving layer material is a dry layer of polymers with good ink receiving properties with usually >5 μm thickness.

The two process steps of wet coating of an ink receiving layer and drying process to remove solvents have impact on product, cost and manufacturing capacity including:
material cost;
investment and operation cost of wet coating machine and drying machine;
manpower resources for operation and maintenance;
manufacturing capacity (two process steps);
yield loss due to misprocessing;
extra efforts on production environment (cleanness environment for wet coating process);
material thickness of ink receiving layer increases total display product thickness; and
possible reliability issues of (polymer) image receiving layer material (e.g. color change under UV or heat in real live product usage).

It is therefore the object of the invention to reduce the above disadvantages.

### SUMMARY OF INVENTION

This problem is solved by a method as mentioned. The method is for manufacturing a color filter in a color electrophoretic display arrangement. The color electrophoretic display arrangement comprises an electrophoretic display media arranged on a backplane, i.e., a substrate provided with a pixel driving array. The method involves the steps of arranging a top encapsulation film attached by an upper optical clear adhesive layer within the color electrophoretic display arrangement and arranging a color pattern between the electrophoretic display media and the top encapsulation film.

The upper optical clear adhesive layer is deposited onto the electrophoretic display media; the color pattern is inkjet-printed onto the upper optical clear adhesive layer wherein the upper optical clear adhesive layer is used as an ink receiving layer; and the top encapsulation film is applied onto the color pattern wherein the adhesive properties of the upper optical clear adhesive layer are used throughout the color pattern attaching the top encapsulation film within the color electrophoretic display arrangement.

As a result of the invention, it has now been discovered that an optical clear adhesive layer has not only adhesive properties but also the property of an ink receiving layer.

The method steps can be executed in the following order:
applying the upper optical clear adhesive layer onto an surface of the electrophoretic display media opposite to the backplane;
inkjet printing of the color pattern onto an surface of the upper optical clear adhesive layer opposite to the electrophoretic display media; and
applying the top encapsulation film onto the surface of the upper optical clear adhesive layer provided with the color pattern.

The color pattern can be applied by an organic solvent based inkjet printing. Particularly, the color pattern can be applied by water based inkjet printing.

The upper optical clear adhesive layer can be applied by laminating.

Also the top encapsulation film can be applied by laminating.

The problem of the invention is also solved by a color filter as mentioned. The invention also relates to a color electrophoretic display arrangement comprising an electrophoretic display media arranged on a backplane, i.e., a substrate provided with a pixel driving array, having a top encapsulation film attached by an upper optical clear adhesive layer within the color electrophoretic display arrangement and a color pattern between the electrophoretic display media and the top encapsulation film The upper optical clear adhesive layer is arranged on the electrophoretic display media; the color pattern is inkjet-printed onto the upper optical clear adhesive layer; and the top encapsulation film is attached onto the color pattern comprising upper optical clear adhesive layer.

A reasonable variation of the color filter according to the invention, includes the layers being arranged in the following order:
the upper optical clear adhesive layer is applied onto a surface of the electrophoretic display media opposite to the backplane;
the color pattern is inkjet printed onto a surface of the upper optical clear adhesive layer opposite to the electrophoretic display media; and
the top encapsulation film is arranged onto the surface of the upper optical clear adhesive layer provided with the inkjet printed color pattern.

The technical advantage of the invention allows to apply inkjet-printing of the color pattern without applying a special ink receiving layer. These process steps are completely avoided from the process flow. Also the lamination of lower optical clear adhesive is not necessary anymore.

For the complete display construction the top encapsulation film is laminated to the electrophoretic display with an optical clear adhesive film anyway.

For this invention it was discovered that typical standard optical clear adhesive films, available commercially, have reasonable good ink reception properties. Therefore, an additional image receiving layer is not required.

### BRIEF DESCRIPTION OF THE DRAWINGS

In the following, the invention is explained in more detail on the basis of an embodiment. In the associated drawings,

FIG. 1 shows an electrophoretic display construction according to the prior art and

FIG. 2 depicts an embodiment of the invention.

### DETAILED DESCRIPTION

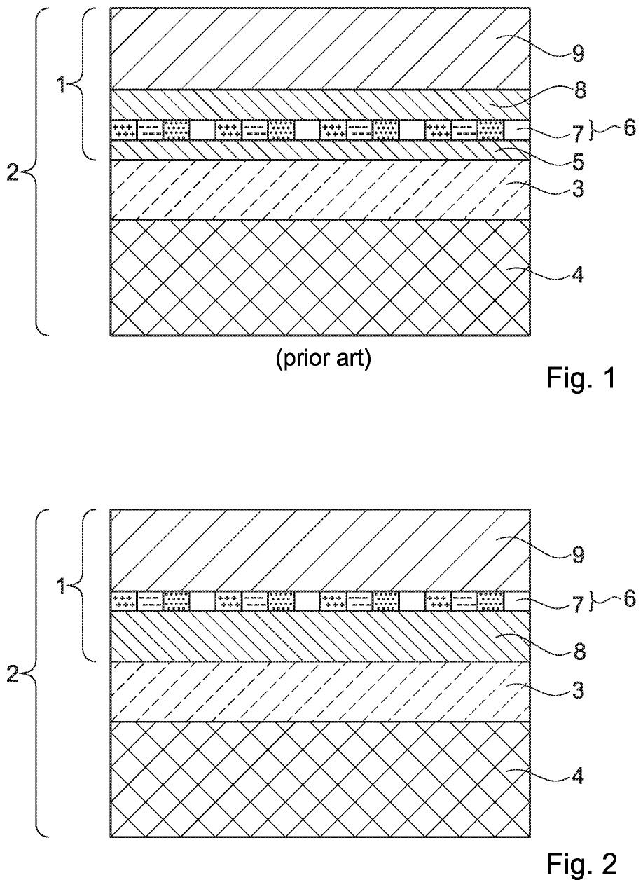

FIG. 1 as showing the prior art was already discussed above.

The electrophoretic display arrangement 2 of FIG. 2 is provided with the color filter 1 according to the invention, and with the electrophoretic display media 3 arranged on the backplane 4.

To produce the color filter 1, the electrophoretic display arrangement 2 is provided with an upper optical clear adhesive layer 8 that adheres to the electrophoretic display media 3.

The color pattern 7 is inkjet-printed onto the upper optical clear adhesive layer 8 wherein the upper optical clear adhesive layer 8 is used as an ink receiving layer; and the top encapsulation film 9 is applied onto the color pattern 7 wherein the adhesive properties of the upper optical clear adhesive layer 8 are used throughout the color pattern 7 attaching the top encapsulation film 9 within the color electrophoretic display arrangement 2.

The layers can be arranged in the following order:
the upper optical clear adhesive layer 8 is applied onto an surface of the electrophoretic display media 3 opposite to the backplane 4;
the color pattern 7 is inkjet printed onto a surface of the upper optical clear adhesive layer 8 opposite to the electrophoretic display media 3; and
the top encapsulation film 9 is arranged onto the surface of the upper optical clear adhesive layer 8 provided with the inkjet printed color pattern 7.

The upper optical clear adhesive film 8 acts as reception layer for solvent and water based inks ensuring accurate ink droplet placement and show no coffee stain effect in dried ink droplets. The basic process steps of creating color filter 1 on electrophoretic display media 3 are now reduced to:
1. Laminating upper optical clear adhesive layer 8 to electrophoretic display media 3;
2. Printing of color ink onto upper optical clear adhesive layer 8 by inkjet printing; and
3. Laminating top encapsulation film 9.

The color pigments from inkjet printing stay on the surface of the upper optical clear adhesive 8. Despite pigments covering portions of the area of the upper optical clear adhesive 8 the adhesion of the upper optical clear adhesive 8 towards the top encapsulation film 9 is still good enough to bond the top encapsulation film 9 firmly to the upper optical clear adhesive 8.

Standard optical clear adhesive material of different thickness can be used. For choosing the right thickness the parallaxe effect of color filter 1 on an electrophoretic display arrangement 2 must be considered. For example, 170 μm square TFT pixel size with ˜80% of TFT area covered with color ink requires optical clear adhesive thickness of maximum 25 μm to avoid parallaxe effect. For smaller TFT pixel size and/or higher color ink area within a TFT pixel area require thinner optical clear adhesive 8. As example typical commercially available optical clear adhesive 8 incorporated with this invention are 3M8171CL and 3M8171PCL.

### REFERENCE SIGNS

1 color filter
2 electrophoretic display arrangement
3 electrophoretic display media
4 backplane
5 lower optical clear adhesive layer
6 color pattern layer
7 color pattern
8 upper optical clear adhesive layer
9 top encapsulation film

1. A method for manufacturing a color filter in a color electrophoretic display arrangement, the color electrophoretic display arrangement comprising an electrophoretic display media arranged on a backplane, including a substrate provided with a pixel driving array, comprising the steps of
arranging a top encapsulation film attached by an upper optical clear adhesive layer within the color electrophoretic display arrangement; and
arranging a color pattern between the electrophoretic display media and the top encapsulation film; and wherein the upper optical clear adhesive layer is deposited onto the electrophoretic display media;
the color pattern is inkjet-printed onto the upper optical clear adhesive layer wherein the upper optical clear adhesive layer is used as an ink receiving layer; and
the top encapsulation film is applied onto the color pattern wherein the adhesive properties of the upper optical clear adhesive layer are used throughout the color pattern attaching the top encapsulation film within the color electrophoretic display arrangement.

2. The method of claim 1, wherein the steps are executed in the following order
applying the upper optical clear adhesive layer onto a surface of the electrophoretic display media opposite to the backplane;
inkjet printing of the color pattern onto a surface of the upper optical clear adhesive layer opposite to the electrophoretic display media; and
applying the top encapsulation film onto the surface of the upper optical clear adhesive layer provided with the color pattern.

3. The method of claim 1, wherein the color pattern is applied by a solvent based inkjet printing.

4. The method of claim 3, wherein the color pattern is applied by water based inkjet printing.

5. The method of claim 1, wherein the upper optical clear adhesive layer is applied by lamination.

6. The method of claim 1, wherein the top encapsulation film is applied by laminating.

7. A color filter in a color electrophoretic display arrangement wherein the electrophoretic display arrangement comprises an electrophoretic display media arranged on a backplane including a substrate provided with a pixel driving array, a top encapsulation film attached by an upper optical clear adhesive layer within the color electrophoretic display arrangement, and a color pattern between the electrophoretic media and the top encapsulation film; and
wherein the upper optical clear adhesive layer is arranged on the electrophoretic display media, the color pattern is inkjet-printed onto the upper optical clear adhesive layer, and the top encapsulation film is attached onto the color pattern having the upper optical clear adhesive layer.

8. The color filter of claim 7, wherein the layers are arranged in the following order
the upper optical clear adhesive layer is applied onto a surface of the electrophoretic display media opposite to the backplane;
the color pattern is inkjet printed onto a surface of the upper optical clear adhesive layer opposite to the electrophoretic display media; and
the top encapsulation film is arranged onto the surface of the upper optical clear adhesive layer provided with the inkjet printed color pattern.

9. The method of claim 2, wherein the color pattern is applied by a solvent based inkjet printing.

10. The method of claim 2, wherein the upper optical clear adhesive layer is applied by lamination.

11. The method of claim 3, wherein the upper optical clear adhesive layer is applied by lamination.

12. The method of claim 2, wherein the top encapsulation film is applied by laminating.

13. The method of claim 3, wherein the top encapsulation film is applied by laminating.

14. The method of claim 4, wherein the top encapsulation film is applied by laminating.
